(19) United States
(12) Patent Application Publication
(10) Pub. No.: US 2012/0111702 A1
(43) Pub. Date: May 10, 2012

(54) TILT SWITCH PREVENTING SOLDERING MATERIAL FROM ENTERNING INTERIOR THEREOF

(75) Inventors: YONG-JIA WANG, Shenzhen (CN); LIANG SUN, Shenzhen (CN)

(73) Assignee: HON HAI PRECISION INDUSTRY CO., LTD., New Taipei (TW)

(21) Appl. No.: 13/241,284

(22) Filed: Sep. 23, 2011

(30) Foreign Application Priority Data
Nov. 5, 2010 (CN) 201020593469.8

(51) Int. Cl. H01H 35/02

(52) U.S. Cl. 200/61.52

(57) ABSTRACT

A tilt switch (100) includes an insulative housing (2), a number of contacts (3) retained in the insulative housing, a conductive rotary ball (4), and a top cover (5) attached to the insulative housing. The insulative housing includes a bottom wall (21) and a number of vertical walls (22) cooperatively defining a receiving space (20). The bottom wall defines a plurality of passageways (211) and a plurality of cutouts (212). The cutouts extend along an up-and-down direction and communicates between the passageways and exterior. Each cutout has a smaller top end and a larger bottom end for preventing soldering material from entering into the receiving space. The contacts are retained in the passageways of the insulative housing. The rotary ball is received in the receiving space and connects with selected ones for establishing different states.

### BACKGROUND OF THE INVENTION

1. Field of the Invention

The present invention relates generally to a tilt switch, and more particularly to a tilt switch which prevents soldering material from entering interior thereof.

2. Description of Related Arts

A tilt switch is assembled on a printed circuit board and includes an insulative housing defining a space, a plurality of contacts retained in the insulative housing, and a rotary ball received in the space. When the tilt switch is tilted at different angles, the rotary ball moves to contact with some different contacts and therefore, different contacts are electrically connected by the rotary ball. Different circuits are turned on and different signals are transmitted thereby. The tilt switch is used for detecting different positions of a device. The contacts comprise a plurality of contacting portions extending into the space for contacting with the rotary ball and a plurality of soldering portions extending out of the insulative housing for soldering with the printed circuit board. The contacting portion of each contact is usually located higher than the corresponding soldering portion. Therefore, during insert molding, a plurality of orientating bars is used for supporting the contacting portions so that the contacts are balancingly placed on a horizontal plane. The insulative housing is insert-molded. Finally, the orientating bars are removed together with all the molds. Therefore, a plurality of cutouts or marks are left in correspondence to positions of the orientating bars. Because the orientating bars are usually regular shaped, each orientating bar has a pair of same sized free ends and thus the cutout defines same sized top end and bottom end, respectively communicating with the space and exterior. The soldering material is prone to enter into the space of the tilt switch when the soldering portions of the contacts are soldered on the printed circuit board.

Hence, a tilt switch preventing soldering material from entering into interior thereof is desired to overcome the aforementioned disadvantage of the prior art.

### SUMMARY OF THE INVENTION

Accordingly, an object of the present invention is to provide a tilt switch preventing soldering material from entering into interior thereof.

To achieve the above object, a tilt switch includes an insulative housing, a number of contacts retained in the insulative housing, a conductive rotary ball, and a top cover attached to the insulative housing. The insulative housing includes a bottom wall and a number of vertical walls cooperatively defining a receiving space. The bottom wall defines a plurality of passageways and a plurality of cutouts. The cutouts extend along an up-and-down direction and communicates between the passageways and exterior. Each cutout has a smaller top end and a larger bottom end for preventing soldering material from entering into the receiving space. The contacts are retained in the passageways of the insulative housing. The rotary ball is received in the receiving space and connects with selected ones for establishing different states.

Other objects, advantages and novel features of the invention will become more apparent from the following detailed description when taken in conjunction with the accompanying drawings.

### BRIEF DESCRIPTION OF THE DRAWINGS

FIG. 1 is a perspective, assembled view of a tilt switch constructed in accordance with the present invention;

FIG. 2 is another view of FIG. 1;

FIG. 3 is a perspective, exploded view of the tilt switch;

FIG. 4 is a top plan view of the tilt switch when the top cover and the rotary ball are both removed;

FIG. 5 is a cross-sectional view when taken along line 5-5 of FIG. 1; and

FIG. 6 is a cross-sectional view when taken along line 6-6 of FIG. 1.

### DETAILED DESCRIPTION OF THE PREFERRED EMBODIMENT

Reference will now be made in detail to the preferred embodiment of the present invention.

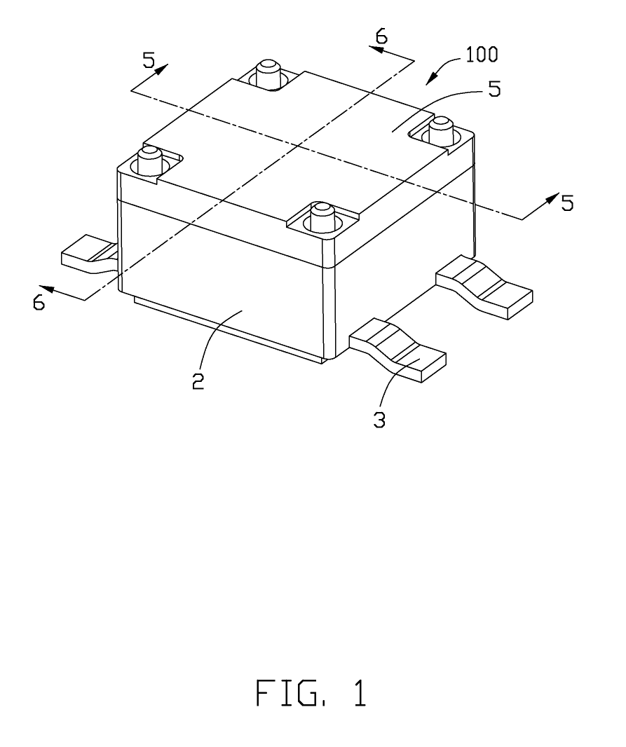

Referring to FIGS. 1-6, a tilt switch 100 in accordance with the present invention, comprises an insulative housing 2 defining a receiving space 20, a plurality of contacts 3 retained in the insulative housing 2, a rotary ball 4 received in the receiving space 20, and a top cover 5 covering the insulative housing 2. The rotary ball 4 is conductive and is selectively connecting with some of the contacts 3 for outputting different signals for detection.

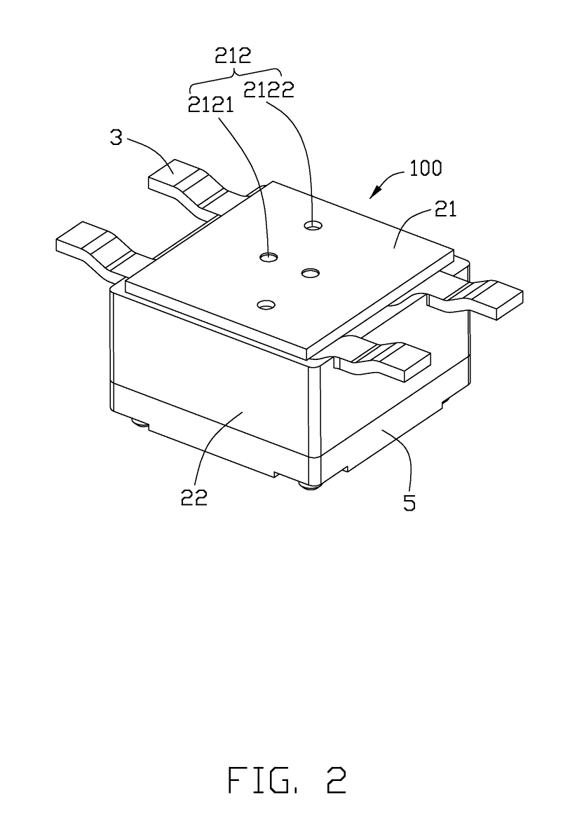

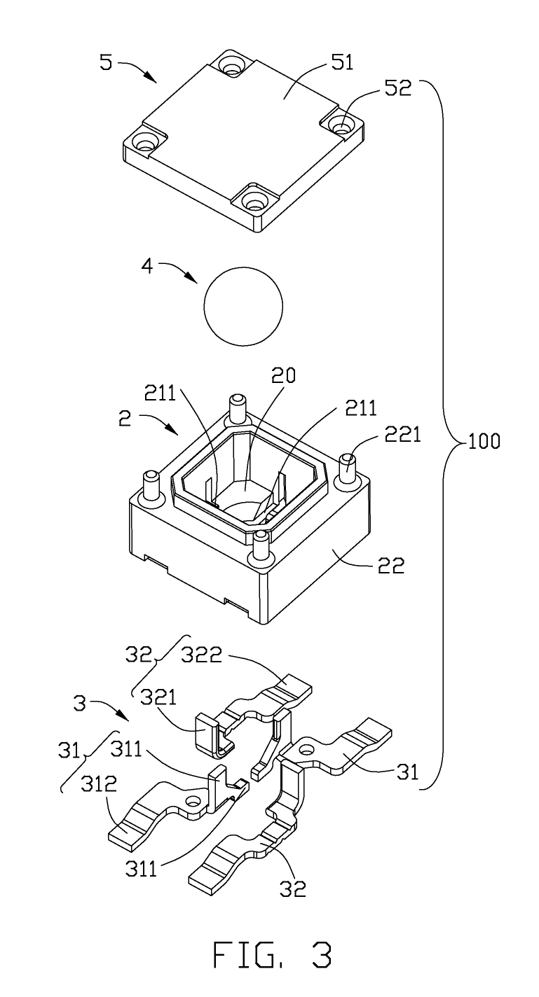

Referring to FIGS. 2 and 3, the insulative housing 2 comprises a bottom wall 21 and a plurality of vertical walls 22 extending upwardly from four edges of the bottom wall 21. The receiving space 20 is defined by the bottom wall 21 and the vertical walls 22. Each corner of every two adjacent vertical walls 22 forms a column 221. The bottom wall 21 defines a plurality of passageways 211. The bottom wall 21 further defines a plurality of cutouts or passages 212 communicating between the corresponding passageways 211 and the exterior. The cutouts or passages 212 are formed and left after a plurality of orientating bars or core pins (not shown) are removed which are used for supporting and/or balancing the contacts 3.

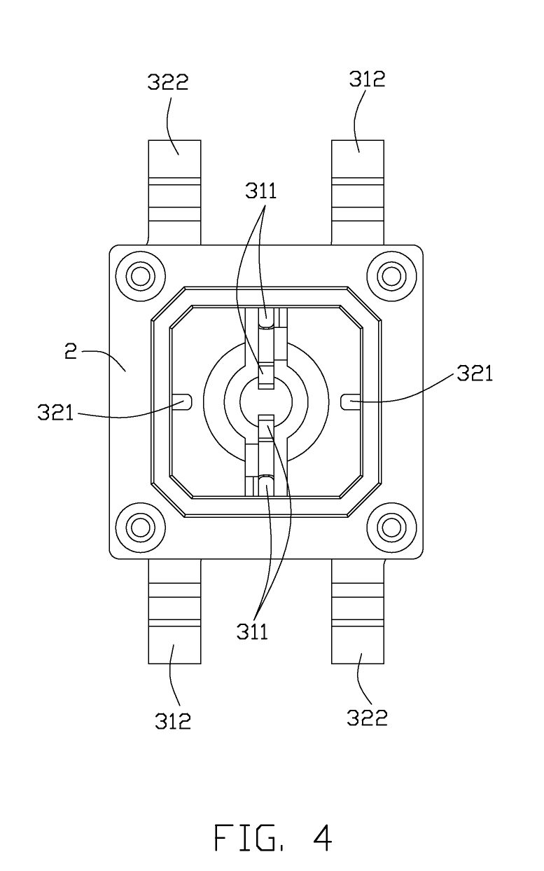

Referring to FIGS. 3 and 4, there are four contacts 3, comprising a pair of first contacts 31 and a pair of second contacts 32. The first contacts 31 and the second contacts 32 are diagonally positioned in the insulative housing 2. Each first contact 31 comprises a first contacting portion 311 extending into the receiving space 20 of the insulative housing 2 and a first soldering portion 312 extending out of the insulative housing 2 from two opposite vertical walls 22 of the insulative housing 2. Correspondingly, each second contact 32 comprises a second contacting portion 321 extending into the receiving space 20 of the insulative housing 2 and a second soldering portion 322 extending out of the insulative housing 2 from the same two opposite vertical walls 22 of the insulative housing 2. The first soldering portions 312 and the second soldering portions 322 are arranged in a same lower plane for being soldered with a printed circuit board (not shown). The first contacting portions 311 and the second contacting portions 321 correspondingly extend curvedly upwardly from the first soldering portions 312 and the second soldering portions 322 and are arranged in a same upper plane for connecting with the rotary ball 4. The first contacting portions 311 deviate a radial direction defined by the soldering portions 312/322 and extend towards the paratactic second contacts 32. Therefore, the first contacting portions 311 come closer to each other. Differently, the second contacting portions 321 extend along the radial direction towards the opposing first soldering portions 312. Therefore, the second contacting portions 321 space from each other for a same distance as the second soldering portions 322.

Referring to FIG. 3, the top cover 5 is a square plate and comprises a main portion 51. The top cover 4 defines four openings 52 on the main portion 51. The openings 52 correspondingly receive the columns 221 and, therefore, the top cover 4 is securely assembled on the insulative housing 2.

When the tilt switch 100 is placed on a horizontal plane, the rotary ball 4 is supported by the first contacting portions 311 and one of the second contacting portions 321. The rotary ball 4 is stable and it is an original state of the tilt switch 100. The circuit outputs an original signal as “C1”. When the tilt switch 100 is at the original state, the first contacting portions 311 support the rotary ball 4 along an up-and-down direction orthogonal to the radial direction and the second contacting portion 321 interferes the rotary ball 4 along a left-and-right direction perpendicular to both the radial direction and the up-and-down direction. When the tilt switch 100 is tilted by a certain angle towards four different directions, the rotary ball 4 is selectively supported by one of the first contacting portions 311 and one of the second contacting portions 321. The circuit outputs respectively different signals as “C2”, “C3”, “C4”, and “C5”. “C2”, “C3”, “C4”, and “C5” mean the tilt switch 100 are at different tilted states. When the tilt switch 100 is at tilted states, the first contacting portion 311 interferes the rotary ball 4 along the radial direction and the second contacting portion 321 interferes the rotary ball 4 along the left-and-right direction. When the tilt switch 100 is reversely placed namely the top cover 5 is located below the insulative housing 2, the rotary ball 4 is supported by the top cover 5 instead of the contacts 3. Therefore, no signal is generated, which means that the tilt switch 100 is in “OFF” state. The tilt switch 100 is alternately changed between the original state, the tilt states and the “OFF” state for detecting purpose.

Referring to FIGS. 1-6, the cutouts 212 are defined on the insulative housing 2 of the tilt switch 100 for communicating between the corresponding passageways 211 and the exterior. The orientating bars extend through the cutouts 212 for supporting the contacting portions 311, 321 of the contacts 3, such that the contacts 3 are balanced placed which facilitates insert-molding of the insulative housing 2. The cutouts 212 are four. Two of the cutouts 212 which are positioned at the middle of the bottom face of the insulative housing 2 are defined as central cutouts 2121. The other two of the cutouts 212 which are positioned at two opposite sides of the middle cutouts 2121 are defined as marginal cutouts 2122. A distance between the central cutouts 2121 is smaller than that of each marginal cutout 2122 and the adjacent central cutout 2121. A first line defined by the central cutouts 2121 is parallel to the radial direction. Second lines defined by the marginal cutouts 2122 and the adjacent central cutouts 2121 are orthogonal to the radial direction. The insulative housing 2 are more easily insert-molded when the cutouts 212 are abovementioned positioned. The cutouts 212 are located below the contacting portions 311, 321 of the contacts 3.

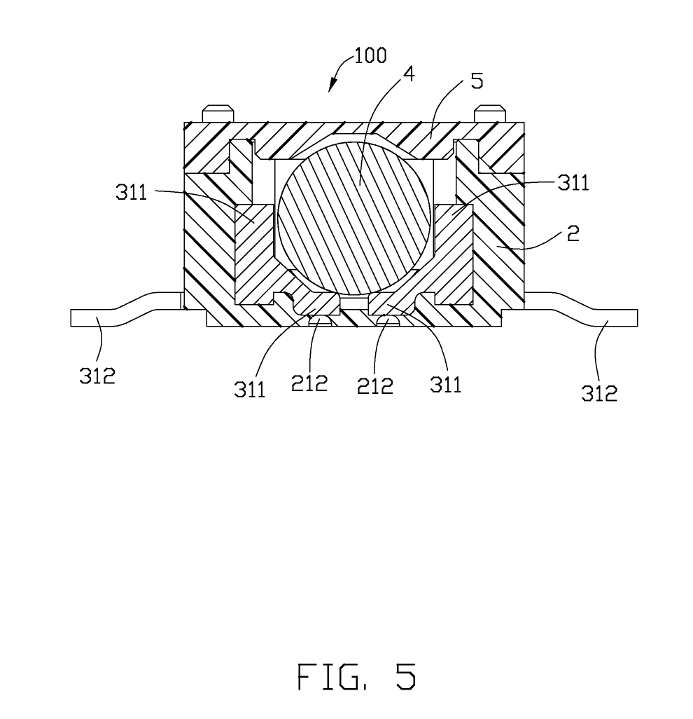

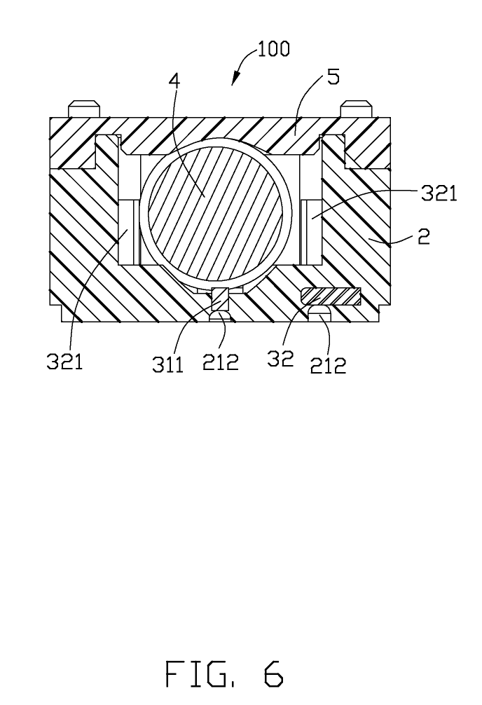

Referring to FIGS. 5 and 6, each cutout 212 has a smaller top end and a larger bottom end, such that preventing soldering material from entering into interior of the tilt switch 100. The cutouts 212 extend along the up-and-down direction for facilitating removal of the orientating bars.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A tilt switch comprising:
an insulative housing comprising a bottom wall and a plurality of vertical walls cooperatively defining a receiving space, the bottom wall defining a plurality of passageways and a plurality of cutouts, the cutouts extending along an up-and-down direction and communicating between the passageways and exterior, each cutout having a smaller top end and a larger bottom end for preventing soldering material from entering into the receiving space;
a plurality of contacts retained in the passageways of the insulative housing;
a conductive rotary ball received in the receiving space and connecting with selected ones for establishing different states; and
a top cover attached to the insulative housing.

2. The tilt switch as claimed in claim 1, wherein the cutouts comprises a pair of central cutouts and a pair of marginal cutouts positioned at two opposite sides of the central cutouts.

3. The tilt switch as claimed in claim 2, wherein a distance between the central cutouts is smaller than that of each marginal cutout and the adjacent central cutout.

4. The tilt switch as claimed in claim 2, wherein the contacts comprises a plurality of soldering portions defining a radial direction and the central cutouts defines a first line parallel to the radial direction.

5. The tilt switch as claimed in claim 4, wherein the marginal cutouts 2122 and the adjacent central cutouts define two second lines orthogonal to the radial direction.

6. The tilt switch as claimed in claim 1, wherein the contacts comprise a plurality of soldering portions located at a first plane and a plurality of contacting portions located at a second plane upper than the first plane.

7. The tilt switch as claimed in claim 6, wherein the cutouts are defined below the corresponding contacting portions.

8. The tilt switch as claimed in claim 6, wherein the contacts comprises a pair of first contacts and a pair of second contacts diagonally positioned in the insulative housing.

9. The tilt switch as claimed in claim 8, wherein the first contacts comprise a pair of first contacting portions deviating a radial direction defined by the first soldering portions and extending towards the paratactic second contacts.

10. The tilt switch as claimed in claim 8, wherein the first contacts comprise a pair of first contacting portions coming closer to each other.

11. The tilt switch as claimed in claim 9, wherein the second contacts comprises a pair of second contacting portions extending along the radial direction towards the opposing first soldering portions.

12. The tilt switch as claimed in claim 10, wherein the second contacts comprises a pair of second contacting portions and a pair of second soldering portions, and the contacting portions space from each other for a same distance as the second soldering portions.

13. An electrical connector comprising:
an insulative housing defining a receiving space;
a plurality of contacts embedded in the housing via an insert molding process, each of said contacts defining a contacting section for contacting a moveable part, a soldering section exposed outside of a bottom surface of the housing for soldering to a printed circuit board, and a median section located between the contacting section and the soldering section for efficiently retaining the contact to the housing; and
the housing defining a plurality of cutouts after the contacts are insert-molded in the housing due to removal of corresponding supporting core pins under condition that said cutouts communicate with an exterior via the bottom surface of the housing; wherein
said the cutout extends in a vertical direction with opposite upper and lower ends, the upper end being smaller than the lower end for preventing upward solder wicking from the bottom surface of the housing.
